(19) United States
(12) Patent Application Publication
(10) Pub. No.: US 2014/0304023 A1
(43) Pub. Date: Oct. 9, 2014

(54) EXTENDING CALENDAR SYSTEM TO EXECUTE DISCOVERABLE TASKS PRIOR TO THE MEETING

(71) Applicant: INTERNATIONAL BUSINESS MACHINES CORPORATION, Armonk, NY (US)

(72) Inventors: Yongcheng Li, Cary, NC (US); Al Chakra, Apex, NC (US); Yuping C. Wu, Cary, NC (US)

(73) Assignee: International Business Machines Corporation, Armonk, NY (US)

(21) Appl. No.: 13/856,802

(22) Filed: Apr. 4, 2013

(51) Int. Cl. G06Q 10/10

(52) U.S. Cl. CPC G06Q 10/1097
USPC 705/7.21

(57) ABSTRACT

There are provided a method, a system and a computer program product for managing an on-line meeting. The system determines one or more tasks to prepare for the on-line meeting. The system calculates a time period that takes in order to complete the one or more tasks before the on-line meeting starts. The system runs the one or more tasks the calculated time period ahead before the on-line meeting starts.

### BACKGROUND

This disclosure relates generally to managing an on-line meeting, and particularly to an electronic calendar system.

### BACKGROUND OF THE INVENTION

An electronic calendar system, e.g., IBM® Lotus Notes® from International Business Machines Corporation, Armonk, N.Y., Microsoft® Outlook® from Microsoft® Corporation, Redmond, Wash., etc., has become an important tool that people use as a guideline which dictates tasks to do and motivates responsibilities to perform those tasks. An electronic calendar system is typically used to schedule events, for example, an on-line or off-line meeting.

A typical scenario for an electronic calendar event, for example, an on-line meeting can be described as follows:
(1) An on-line meeting host schedules an on-line meeting with one or more of: a conference calling number, eMeeting URL (Uniform Resource Locator), presentation charts, and other relevant materials or information. (eMeeting URL refers to a web address via which an on-line meeting is held. By typing eMeeting URL on a web browser, e.g., firefox® from Mozilla® Corporation, Mountain View, Calif., and then providing a valid credential to log in, eMeeting tool, e.g., Adobe® Connect from Adobe® Systems Inc., Mountain View, Calif., may be launched. By using the eMeeting tool, a host and participants can hold a web conference in which a host and participants may be shown as icons. During the web conference that uses the eMeeting tool, a host can show the presentation charts and can speak to other participants via a microphone (a participant can also speak if the host grants a “speak” right to that participant, e.g., by clicking a “microphone” icon of that participant); then, the voice of the host is delivered to participants via a network, e.g., a wireless network or wired network; participants can also chat with each other, e.g., by clicking a chat icon.)
(2) An invitation to the on-line meeting is sent, e.g., via an email, etc., to all participants who will accept the invitation.
(3) At the time of the on-line meeting, meeting participants will dial the conference calling number, open a web browser, type the eMeeting URL, and log in. Dialing the conference calling number can be avoided if an on-line meeting host or an on-line meeting participant can speak through a microphone connected to a computer by which the host and the participant joins the on-line meeting.
(4) The host may enable screen sharing by selecting an entire screen, software application(s) or electronic document(s).
(5) After starting the on-line meeting, the on-line meeting host or the on-line meeting participants may perform a research on a history, a topic, etc. related to the on-line meeting. For example, the host or one of the participants may go back to previous emails or other communications.
(6) If other materials are needed for the on-line meeting, the host or the participants may also launch software applications related to those materials.

Those steps (5)-(6) can take, for example, about 2 or 3 minutes. When there is no preceding meeting, the host or the participant(s) perform the steps (5)-(6) before the on-line meeting starts. When there is a preceding meeting, or the host or the participant(s) are otherwise occupied, the host or the participant(s) often consume the meeting time (or another occupied time), e.g., in order to launch the software application(s) or electronic document(s). By considering the number of on-line meetings people have and the number of participants in those on-line meetings, time may be wasted in preparing for on-line meetings and consequently the productivity of those people gets lost.

### SUMMARY

There are provided a method, a system and a computer program product for managing an on-line meeting. The system determines one or more tasks to prepare for the on-line meeting. The system calculates a time period that takes in order to complete the one or more tasks before the on-line meeting starts. The system runs the one or more tasks the calculated time period ahead before the on-line meeting starts.

Each of the one or more tasks includes at least one property which includes one or more of: a name of the each task, a description of the each task, at least one input parameter of the each task, an estimated run-time of the each task, at least one pre-requisite of the each task, an implementation of the each task.

In order to calculate the time period, the system may monitor resource utilization of a user's computer. The system may compare the monitored resource utilization to a pre-determined standard. The system may determine, based on the comparing, whether the user's computer is a machine whose available resources do not meet the pre-determined standard.

In order to calculate the time period, the system may monitor network bandwidth associated with a user's computer. The system may compare the monitored network bandwidth to a pre-determined standard. The system may determine, based on the comparing, whether the user's computer is connected to a network whose available network bandwidth is less than the pre-determined standard.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates a flow chart run in order to manage an on-line meeting;

FIGS. 2-3 illustrate flow charts that describe methods for calculating a time period that takes in order to complete one or more tasks before an on-line meeting starts;

FIG. 4 illustrates example computing systems that run the method steps illustrated in FIGS. 1-3;

FIG. 5 illustrates a system diagram that depicts an example system that manages an on-line meeting;

FIG. 6 illustrates an example table that describes properties of an example task; and

FIG. 7 illustrates an example table that describes changing an order of tasks to run depending on a time left until an on-line meeting starts.

### DETAILED DESCRIPTION

There is a need to enhance an electronic calendar system that can integrate a machine learning algorithm, e.g., a supervised learning algorithm or unsupervised learning algorithm, in helping users improve the productivity of the users by using the electronic calendar system.

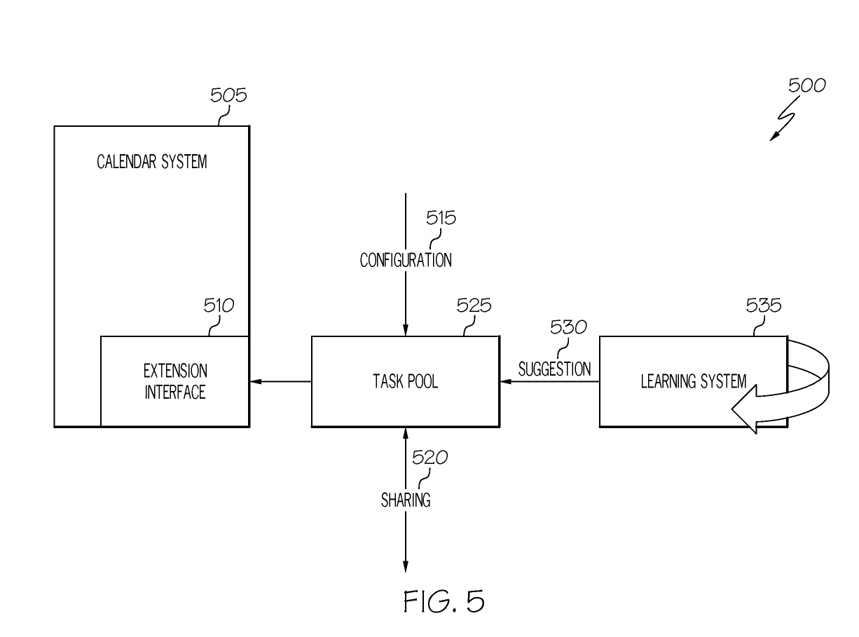

In one embodiment, there is provided an electronic system (e.g., an electronic system 500 shown in FIG. 5) that allows running of user-defined or learning actions to prepare for a calendar event. By running those actions, the electronic system can reduce the time users spend in order to prepare for an on-line meeting and thus improve the productivity of the users. By using the electronic system, a user can save at least several minutes per meeting and thereby increase his (or her) productivity. The value of this increase of the productivity per each user increases exponentially if this electronic system is employed by a company that has many workers, e.g., more than 1,000 workers, who have on-line meetings frequently with multiple participants.

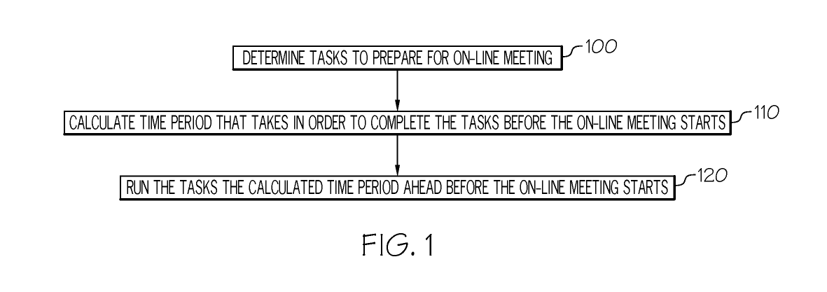

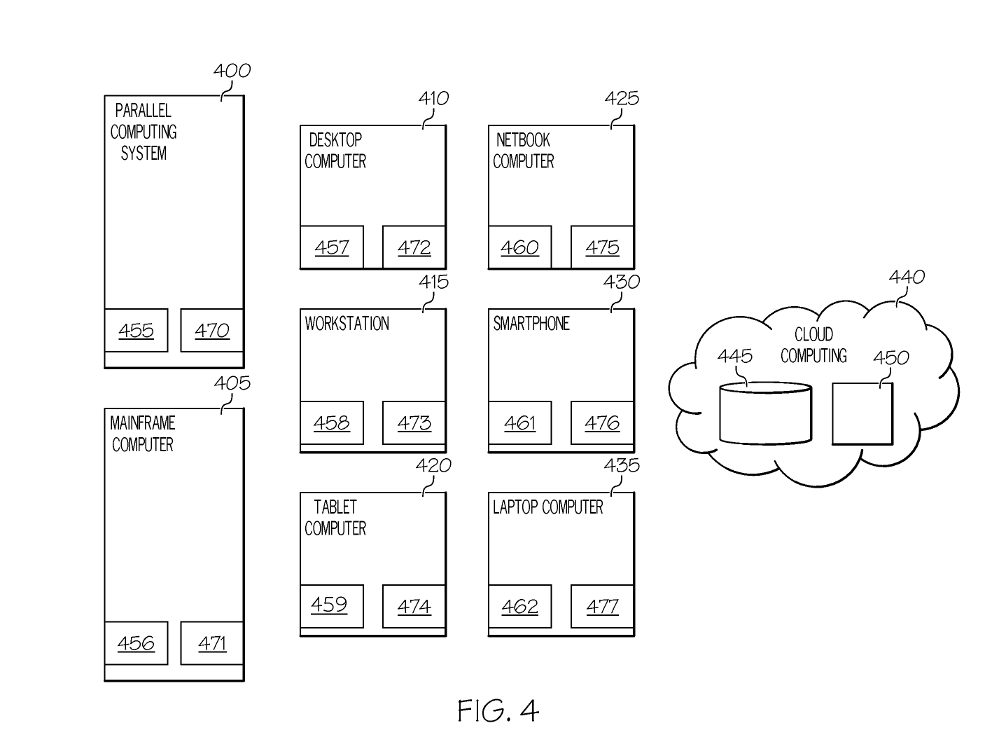

FIG. 5 illustrates the electronic system 500 that manages an on-line meeting. The electronic system 500 runs method steps shown in FIG. 1. In one embodiment, the electronic system 500 is implemented on one or more computing systems. In this embodiment, the one or more computing systems may run the electronic system 500 which is software application programmed by using a programming language, e.g., C++, Java, etc. FIG. 4 illustrates examples of computing systems that can run the electronic system 500. These computing systems may include, but are not limited to: a parallel computing system 400 including at least one processor 455 and at least one memory device 470, a mainframe computer 405 including at least one processor 456 and at least one memory device 471, a desktop computer 410 including at least one processor 457 and at least one memory device 472, a workstation 415 including at least one processor 458 and at least one memory device 473, a tablet computer 420 including at least one processor 456 and at least one memory device 474, a netbook computer 425 including at least one processor 460 and at least one memory device 475, a smartphone 430 including at least one processor 461 and at least one memory device 476, a laptop computer 435 including at least one processor 462 and at least one memory device 477, or a cloud computing system 440 including at least one storage device 445 and at least one server device 450.

In another embodiment, the electronic system 500 may be implemented as hardware on a reconfigurable hardware, e.g., FPGA (Field Programmable Gate Array) or CPLD (Complex Programmable Logic Device), using a hardware description language (Verilog, VHDL, Handel-C, or System C). In another embodiment, the electronic system 500 may be implemented on a semiconductor chip, e.g., ASIC (Application-Specific Integrated Circuit), using a semi custom design methodology, i.e., designing a semiconductor chip using standard cells and a hardware description language.

Returning to FIG. 1, at 100, the electronic system 500 determines one or more tasks to prepare for the on-line meeting. The electronic system 500 determines the one or more tasks, e.g., by using a machine learning algorithm (e.g., supervised learning algorithm or unsupervised learning algorithm). For example, a particular user always launches a particular software application, e.g., a web browser, during on-line meetings. By using a machine learning algorithm and by using a computer monitoring software application (e.g., SpyAgent® from Spytech® Software and Design Inc., Minnesota, WebWatcher™ from Awareness Technologies, Westport, Conn., etc.) that monitors and records a behavior of this user while the user uses his (or her computer), the electronic system 500 is trained to launch the particular software application before on-line meetings, in which the user is a host or a participant, start.

In another embodiment, a user determines the one or more tasks to be prepared before the on-line meeting starts. A user includes, but is not limited to: a host of the on-line meeting, or a participant of the on-line meeting. A task includes, but is not limited to: running a software application on a user's computer, running a set of software applications on the user's computer, performing at least one action to learn information associated with the each task, or combinations thereof. In a further embodiment, the user can add one or more tasks manually to the electronic system 500, e.g., by using a keyboard, a mouse, or other input device. A participant of an on-line meeting may request a host of that on-line meeting to add a specific task (e.g., launching a specific software application or a specific electronic document before the on-line meeting starts, etc.) in order to prepare for the on-line meeting.

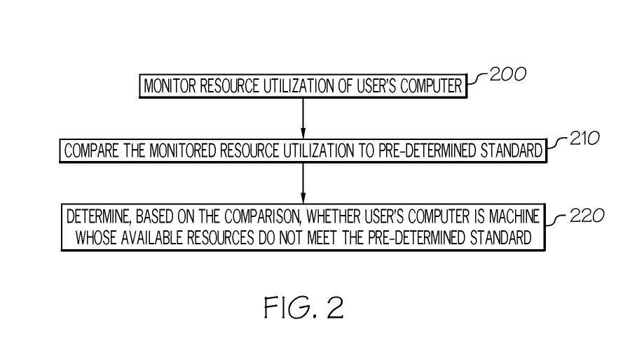

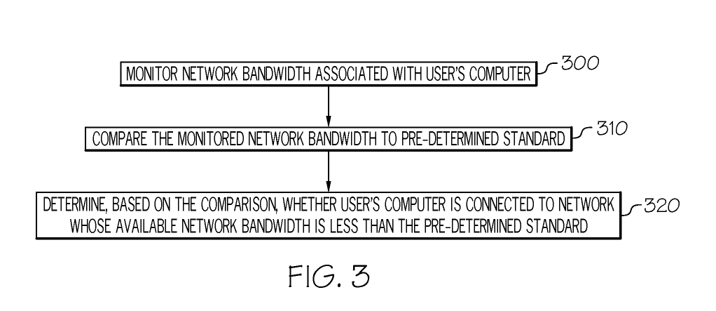

Returning to FIG. 1, at 110, the electronic system 500 calculates a time period that takes in order to complete the one or more tasks before the on-line meeting starts. FIGS. 2-3 illustrate flow charts that describe a method for calculating the time period that takes in order to complete the tasks before the on-line meeting starts. In FIG. 2, at 200, the electronic system 500 monitors resource utilization of a user's computer, e.g., by using Windows® Task Manager from Microsoft® Corporation, Redmond, Wash. Monitored resource utilization includes, but is not limited to: CPU (Central Processing Unit) usage or another processor usage, available memory space, available network bandwidth, etc. At 210, the electronic system 500 compares the monitored resource utilization to a pre-determined standard, for example, a CPU usage of a user's computer shall be less than 50%. At 220, the electronic system 500 determines, based on the comparison, whether the user's computer is a machine whose available resources do not meet the pre-determined standard. If the user's computer has available resources less than the pre-determined standard, the electronic system 500 launches the tasks a first pre-determined time period, e.g., 5 minutes, ahead before the on-line meeting starts. If the user's computer has available resources more than the pre-determined standard, the electronic system 500 launches the tasks a second pre-determined time period, e.g., 1 minute, ahead before the on-line meeting starts. In one embodiment, the electronic system 500 can be programmed, e.g., by using a programming language, to dynamically change the first and second pre-determined time periods according to available resources of the user's computer.

FIG. 3 illustrates a methodology that utilizes a network bandwidth associated with the user's computer in order to calculate the time period that takes in order to complete the tasks before an on-line meeting. At 300, the electronic system 500 monitors a network bandwidth associated with the user's computer, e.g., by using Windows® Task Manager from Microsoft®Corporation, Redmond, Wash., well-known “Ping” test, or other test. The electronic system 500 compares the monitored network bandwidth to a pre-determined standard. The electronic system 500 determines, based on the comparison, whether the user's computer is connected to a network whose available network bandwidth is less than a pre-determined standard. If the user's computer is connected to a network whose available network bandwidth is less than the pre-determined standard, the electronic system 500 launches the tasks (e.g., launching of eMeeting tool, etc.) the first pre-determined time period, e.g., 5 minutes, ahead before the on-line meeting starts. If the user's computer is connected to a network whose available network bandwidth meets the pre-determined standard, the electronic system 500 launches the tasks the second pre-determined time period, e.g., 1 minute, ahead before the on-line meeting starts. In one embodiment, the electronic system 500 can be programmed, e.g., by using a programming language, to dynamically change the first and second pre-determined time periods according to available network bandwidth associated with the user's computer.

In a further embodiment, the electronic system 500 monitors only one resource utilization, e.g., only available network bandwidth. Based on this only one monitored resource utilization, the electronic system 500 calculates the time period that takes in order to complete the tasks before an on-line meeting starts, e.g., by running method steps in FIG. 3.

In another embodiment, the electronic system 500 simultaneously monitors multiple resource utilizations, e.g., CPU usage and available network bandwidth. In this embodiment, the electronic system 500 sets a priority between those monitored multiple resource utilizations. For example, the electronic system 500 may set “CPU usage” has a higher priority than “available network bandwidth.” This priority may be pre-determined by a user. Alternatively, a user may program the electronic system 500, e.g., by using a programming language, to be able to modify the priority when the user wants to modify the priority. For example, the electronic system 500 may provide a graphical user interface (not shown) to the user by which the user can modify the priority.

This priority can be used to resolve a conflict that can occur if the electronic system 500 monitors that a resource utilization of a user's computer meets a pre-determined standard and also monitors that another resource utilization of that user's computer does not meet another pre-determined standard. When this or similar conflict occurs, the electronic system 500 determines, e.g., based on the priority set by the user, which monitored resource utilization has a higher priority, and then disregards a monitored resource utilization which has a lower priority. For example, assume that the electronic system 500 monitors a CPU usage of a user's computer meets a first pre-determined standard but available network bandwidth of that user's computer does not meet a second pre-determined standard. Further assume that CPU usage is a higher priority than the available network bandwidth in calculating the time period. Then, in this example, the electronic system 500 calculates the time period based on that the CPU usage of the user's computer meets the first pre-determined standard. The electronic system 500 disregards that the available network bandwidth associated with the user's computer does not meet the second pre-determined standard.

In order to calculate the time period, other methodologies may be utilized, for example, a weighted method that assigns a weight to each resource utilization. In this weighted method, a user may provide to the electronic system 500 a mathematical formula that computes a resource utilization rate of a user's computer based on the weight(s) and current resource utilization of that user's computer. For example, the resource utilization rate of the user's computer may be computed by: resource utilization rate=(a×current CPU usage)+(b×current available network bandwidth)+(c×current memory usage), where a is a weight assigned to CPU usage, b is a weight assigned to available network bandwidth, and c is a weight assigned to memory usage. If the resource utilization rate computed from the formula is more than a pre-determined standard, the electronic system 500 launches the tasks the first pre-determined time period, e.g., 5 minutes, ahead before the on-line meeting starts. If the resource utilization rate is less than the pre-determined standard, the electronic system 500 launches the tasks the second pre-determined time period, e.g., 1 minute, ahead before the on-line meeting starts. In one embodiment, the user may also modify the formula, e.g., via a graphical user interface (not shown) of the electronic system 500.

Returning to FIG. 1, at 120, the electronic system 500 runs the tasks the calculated time period ahead before the on-line meeting starts. In one embodiment, the electronic system 500 runs the tasks as a background process of the user's computer before the on-line meeting starts. This background processing feature of the tasks ensures that no data is revealed to a wrong participant who is not invited to the on-line meeting. For example, the electronic system 500 pre-launches software applications that are needed for a next on-line meeting. The electronic system 500 runs these pre-launched software applications in the background only. Thus, these pre-launched software applications would not be visible on the screen of the user's computer. Once an eMeeting tool (e.g., WebEx® from Cisco® Systems, Inc., San Francisco, Calif., Adobe® Connect from Adobe® Systems Inc., Mountain View, Calif., etc.) associated with a previous meeting is closed and a current eMeeting tool (e.g., WebEx® from Cisco® Systems, Inc., San Francisco, Calif., Adobe® Connect from Adobe® Systems Inc., Mountain View, Calif., etc.) is opened, the electronic system verifies a corresponding meeting identification number, e.g., by matching a meeting identification number available on the electronic system 500 and a meeting identification number provided from eMeeting tool. Upon verifying the meeting identification number, the electronic system 500 allows participants of a corresponding on-line meeting to see contents of the pre-launched software applications. By running the method steps shown in FIGS. 1-3, the electronic system 500 can reduce a lag time to start an on-line meeting.

FIG. 5 illustrates components of the electronic system 500. The electronic system 500 includes, but is not limited to: an electronic calendar system 505, an extension interface 510, a configuration component 515, a task sharing component 520, a task pool 525, and a learning system 535. The electronic calendar system 505 may include any electronic calendar system that includes, but is not limited to: Microsoft® Outlook from Microsoft® Corporation, Redmond, Washington, IBM® Lotus Notes from International Business Machines Corporation, Armonk, N.Y., etc. The extension interface 510 allows the user to define the task(s) (or a list of the tasks), and runs the tasks the calculated time period before the on-line meeting starts.

The task pool 525 may include, but is not limited to: a database system (e.g., IBM® DB2® from International Business Machines Corporation, Armonk, N.Y., etc.) and a storage device (e.g., solid state drive, etc.). The task pool 525 stores the defined tasks in the database or the storage device. In one embodiment, each task includes at least one property which includes one or more of: a name of the task, a description of the task, at least one input parameter of the task, an estimated run-time of the task, at least one pre-requisite of the task, an implementation of the task.

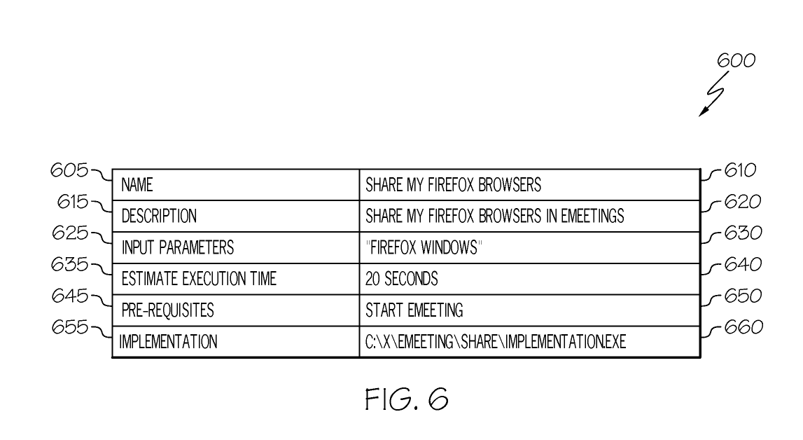

FIG. 6 illustrates an example table 600 that describes example properties of an example task. This example task would be to share a software application (or a set of software applications) of the user with other on-line meeting participants during the on-line meeting. A name 605 of this example task would be “share the software application (or the set of software applications)” 610. A description 615 of this example task would be “share the software application (or the set of software applications) in eMeeting” 620. Input parameters 625 of this example task would be the software application (or the set of software applications) 630 operable on the user's computer. Estimate run-time of this example task would be, for example, 20 seconds 640. Pre-requisites 645 of this example task would be starting of the on-line meeting 650. An implementation 655 would be a file path to the software application on the user's computer, or file paths to the set of software applications on the user's computer. In one embodiment, a task can be created, e.g. by a user, with only a name 605 and a corresponding description 615. A corresponding implementation 655 may be provided, e.g., by that user, after the creation of the task.

Returning to FIG. 5, the configuration component 515 allows a user (e.g., an on-line meeting host, etc.) to determine an order of the tasks to run in order for the tasks are completed before the on-line meeting starts. The configuration component 515 may be programmed, e.g., by using programming language, to change the determined order according to a time left until the starting of the on-line meeting.

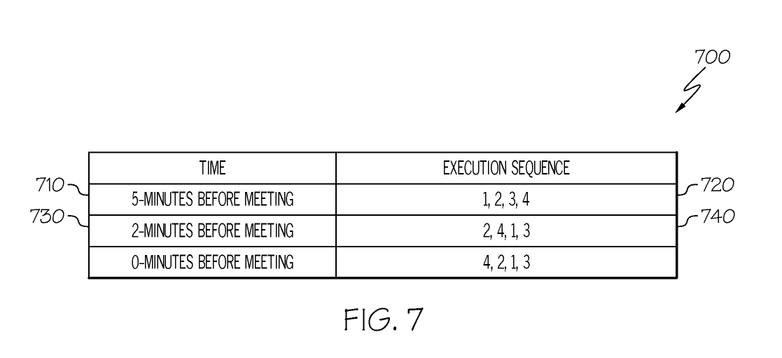

For example, the user may specify an order to run tasks. An example order to run example tasks is as follows:
1. Open my presentation of “xyz”.
2. Start eMeeting.
3. Share my presentation application.
4. Dial-in a conference call number.
   FIG. 7 illustrates an example table 700 that describes this example order which can be changed in a time-dependent manner. For example, if 5 minutes are left (710) until a corresponding on-line meeting starts, the configuration component 515 determines that the order of the example tasks to run would be “1, 2, 3, 4” (720). However, if 2 minutes are left (730) until a corresponding on-line meeting starts, the configuration component 515 determines that the order of the example tasks to run would be “2, 4, 1, 3” (740). The remaining time till the start of an on-line meeting would be measured from a launch of the electronic system 500. For example, the user launches the electronic system 500 2 minutes before the corresponding on-line meeting starts, the configuration component 515 sets up the order of the example task to run as “2, 4, 1, 3” (740).

In one embodiment, the extension interface 510 automatically starts to run the tasks right after the configuration component 515 determines or changes the order of the tasks to run. In another embodiment, the user manually initiates the running of the tasks right after the user determines, through the configuration component 515, the order of the tasks to run.

The learning system 535 includes one or more computer monitoring software applications and employs one or more machine learning algorithms. The learning system 535 monitors a user's computer by which the user joins a corresponding on-line meeting. The learning system 535 suggests 530, e.g., by running the machine learning algorithm with data generated from the computer monitoring software application, at least one manual action to be taken prior to the starting of the corresponding on-line meeting. For example, the computer monitoring software application may monitor and record that a particular user always launch a web browser whenever that user joins a web conference at LOAM EST every Tuesday. Based on this record, by running a supervised learning algorithm which predicts a same output when same inputs are given, the learning system 535 may suggest launching a web browser to that user whenever that user is expected to join a web conference at 10AM EST on Tuesday. This manual action can be automated, e.g., by programming the extension interface 510 to perform the action prior to the starting of the on-line meeting.

Returning to FIG. 5, the task sharing component 520 enables the task pool 525 and the configuration component 515 to be shared with other users. For example, the user may store certain tasks, properties of these tasks, and an order of these tasks to run, in a shared storage device (not shown) managed by the task pool 525 and the configuration component 515. In this way, the other users may be able to access and view the certain tasks and the order of the certain tasks to run.

The task sharing component 520 allows a first user to import at least one task that belongs to a second user, e.g., by accessing the shared storage device and retrieving a task from the shared storage device. When importing the task that belongs to the second user, the task sharing component 520 may also import properties of the second user's task, e.g., from the shared storage device. The task sharing component 520 may also allow the first user to customize the imported properties of the second user's task, for example, changing the name of the task.

The task sharing component 520 also enables communication(s) between different users, e.g., via emails, instant messaging, etc. For example, if a first user requests an implementation property (e.g., implementation property 655 shown in FIG. 6) of a task to a second user, then the second user supplies the implementation property requested by the first user, e.g., via an instant messaging.

In one embodiment, the task sharing component 520 allows sharing of tasks among with internal meeting participants in an organization that a user works for, e.g., by providing a valid credential to the internal meeting participant which allows an access to the shared storage device that stores sharable tasks. The task sharing component 520 prevents the tasks from being shared with external meeting participants who do not work for the organization, e.g., by not providing any credential to the external meeting participants that is needed to access the shared storage device.

In one embodiment, the electronic system 500 can apply methods shown in FIGS. 1-3 to webcasts, e-learning, etc. in order to increase productivity of hosts or participants of the webcasts and e-learning.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for managing an on-line meeting, the method comprising:
determining one or more tasks to prepare for the on-line meeting;
calculating a time period that takes in order to complete the one or more tasks before the on-line meeting starts; and
running the one or more tasks the calculated time period ahead before the on-line meeting starts,
wherein a processor coupled to a memory device performs the steps of: determining, calculating and running.

2. The method according to claim 1, wherein each of the one or more tasks includes at least one property which includes one or more of: a name of the each task, a description of the each task, at least one input parameter of the each task, an estimated run-time of the each task, at least one pre-requisite of the each task, an implementation of the each task.

3. The method according to claim 2, wherein each of the one or more tasks comprises one or more of:
running a software application on a user's computer;
running a set of software applications on the user's computer;
performing at least one action to learn information associated with the each task; or
combinations thereof.

4. The method according to claim 3, wherein the implementation of the each task specifies one or more of:
a file path to the software application on the user's computer; or
file paths to the set of software applications on the user's computer.

5. The method according to claim 1, further comprising:
determining an order of the one or more tasks to run;
changing the determined order according to a time left until the starting of the on-line meeting.

6. The method according to claim 1, further comprising:
monitoring a user's computer; and
suggesting, based on the monitoring, at least one manual action to be taken prior to the starting of the on-line meeting.

7. The method according to claim 2, further comprising:
importing at least one task that belongs to another user;
importing properties of the another user's task; and
customizing the imported properties of the another user's task.

8. The method according to claim 1, wherein the one or more tasks are being shared with internal meeting participants in an organization that the user works for, but the one or more tasks are prevented from being shared with external meeting participants who do not work for the organization.

9. The method according to claim 1, wherein the step of calculating comprises:
monitoring resource utilization of a user's computer;
comparing the monitored resource utilization to a pre-determined standard; and
determining, based on the comparing, whether the user's computer is a machine whose available resources do not meet the pre-determined standard.

10. The method according to claim 1, wherein the step of calculating comprises:
monitoring network bandwidth associated with a user's computer;
comparing the monitored network bandwidth to a pre-determined standard; and
determining, based on the comparing, whether the user's computer is connected to a network whose available network bandwidth is less than the pre-determined standard.

11. The method according to claim 1, whereby a lag time to start the on-line meeting is reduced.

12. The method according to claim 3, wherein the user is one of:
a host of the on-line meeting; or
an invitee of the on-line meeting.

13. The method according to claim 12, wherein the user determines the one or more tasks.

14. The method according to claim 1, wherein an electronic system, which integrates a machine learning algorithm, determines the one or more tasks.

15. A system for managing an on-line meeting, the method comprising:
at least one memory device;
a processor coupled to the memory device,
wherein the processor is configured to perform steps of:
determining one or more tasks to prepare for the on-line meeting;
calculating a time period that takes in order to complete the one or more tasks before the on-line meeting starts; and
running the one or more tasks the calculated time period ahead before the on-line meeting starts.

16. The system according to claim 15, wherein each of the one or more tasks includes at least one property which includes one or more of: a name of the each task, a description of the each task, at least one input parameter of the each task, an estimated run-time of the each task, at least one pre-requisite of the each task, an implementation of the each task.

17. The system according to claim 16, wherein each of the one or more tasks comprises one or more of:
running a software application on a user's computer;
running a set of software applications on the user's computer;
performing at least one action to learn information associated with the each task; or
combinations thereof.

18. The system according to claim 15, wherein in order to calculate the time period, the processor is further configured to perform steps of:
monitoring resource utilization of a user's computer;
comparing the monitored resource utilization to a pre-determined standard; and
determining, based on the comparing, whether the user's computer is a machine whose available resources do not meet the pre-determined standard.

19. A computer program product for managing an on-line meeting, the computer program product comprising a storage medium that excludes a propagating signal, the storage medium readable by a processing circuit and storing instructions run by the processing circuit for performing a method, said method steps comprising:
determining one or more tasks to prepare for the on-line meeting;
calculating a time period that takes in order to complete the one or more tasks before the on-line meeting starts; and
running the one or more tasks the calculated time period ahead before the on-line meeting starts.

20. The computer program product according to claim 19, wherein the step of calculating comprises:
monitoring network bandwidth associated with a user's computer;
comparing the monitored network bandwidth to a pre-determined standard; and
determining, based on the comparing, whether the user's computer is connected to a network whose available network bandwidth is less than the pre-determined standard.
